(19) United States
(12) Patent Application Publication
(10) Pub. No.: US 2023/0394531 A1
(43) Pub. Date: Dec. 7, 2023

(54) Systems and Methods for Compensating a User and Displaying Advertisement on a Device

(71) Applicant: Adebowale AJAGBE, Livonia, MI (US)

(72) Inventor: Adebowale AJAGBE, Livonia, MI (US)

(21) Appl. No.: 18/250,557

(22) PCT Filed: Oct. 27, 2020
(86) PCT No.: PCT/US2020/057491

§ 371 Date: Apr. 26, 2023

(51) Int. Cl. G06Q 30/0251; G06Q 30/0207

(52) U.S. Cl. CPC G06Q 30/0271; G06Q 30/0207

(57) ABSTRACT

Methods, devices, and systems for compensating a user for viewing advertisements displayed on an electronic device is provided. The method and system may be implemented on an electronic device. The method includes providing a list of interests. The method further includes receiving a selected interest from the list of interests. The method further includes detecting an end of the communication operation. The method further includes displaying, on the display, a link to view an advertisement related to the selected interest after the end of the communication operation, and compensating the user when the advertisement is viewed. In a second embodiment, methods, devices, and systems are provided to deliver advertisement to a user viewing a media content on an electronic device. In such an embodiment, the advertisement is played when the media content is paused, rewound or forwarded.

### CROSS-REFERENCE TO RELATED APPLICATIONS

This application is the U.S. national stage of PCT/US2020/057491 filed on Oct. 27, 2020, the contents of which are incorporated herein.

### TECHNICAL FIELD

This disclosure relates generally to a method, system and device for compensating a user and displaying advertisement on a device.

### BACKGROUND

Electronic devices such as a mobile device, a laptop computer, a desktop or a tablet are configured to execute electronic communications such as text messaging and phone calls and the like. The electronic devices are also configured to access the internet wherein the user may view videos through various internet based applications such as websites, podcasts or the like. As an example, the internet based applications include YouTube, the discovery channel, Netflix, and the like. In many instances, the video is displayed after an advertisement is posted. In many instances, the advertisements are irrelevant to the user. Currently, the internet based applications is compensated by the company that is being advertised based on the number of views, clicks or visits the internet based applications receives.

Accordingly, it remains desirable to have a method or device which delivers advertisement based upon the interests of the user. It further remains desirable to have a method or device which compensates the user for viewing (or engaging) an advertisement.

### SUMMARY

The instant disclosure provides various methods, devices, and systems for compensating a user operating a device. One aspect of the disclosure provides a method. The method includes providing a list of interests. The list of interests may be list of activities, hobbies, political and environmental causes and the like. The method further includes receiving a selected interest from the list of interests. The user may select an interest from the list of interest so as to provide a selected interest. The method further includes detecting a communication operation executed on the device. The communication operation may be a phone call, a text message, a video call or the like. The method further includes detecting an end of the communication operation. The method further includes playing an advertisement related to the selected interest after the end of the communication operation. The method further includes compensating the user when the advertisement is viewed.

Implementations of the disclosure may also include one or more of the following features. In some implementations, an advertisement input is provided which provides an option to view the advertisement instantaneously or at a later point in time.

In some implementations, the advertisement may be closed after a predetermined period of time.

In some implementations, the compensation may be a credit redeemable for a monetary amount, tangible goods or digital products.

In some implementations, the method includes an input for selecting one of the interests from the list of interests.

In some implementations, the selected interest is determined based upon a profile of the user.

In some implementations, the selected interest is determined based upon a plurality of software applications downloaded onto the device.

According to another aspect of the disclosure, a device is provided. The device includes a display, a text input, a microphone and a speaker. The device further includes data processing hardware in communication with the display. The user device further includes memory hardware in communication with the data processing hardware. The memory hardware stores instructions that when executed on the data processing hardware cause the data processing hardware to perform operations. According to this aspect, the operations carry out a method. The method includes providing a list of interests. The list of interests may be list of activities, hobbies, political and environmental causes and the like. The method further includes receiving a selected interest from the list of interests. The user may select an interest from the list of interest so as to provide a selected interest. The method further includes detecting a communication operation executed on the device. The communication operation may be a phone call, a text message, a video call or the like. The method further includes detecting an end of the communication operation. The method further includes displaying, on the display, a link to view an advertisement related to the selected interest after the end of the communication operation. The method further includes compensating the user when the advertisement is viewed.

Implementations of the disclosure may also include one or more of the following features. In some implementations, the link includes an option to view the advertisement instantaneously or at a later point in time.

In some implementations, the advertisement includes an input configured to close the advertisement after a predetermined period of time.

In some implementations, the compensation may be a credit redeemable for a monetary amount.

In some implementations, the method includes an input for selecting one of the interests from the list of interests.

In some implementations, the selected interest is determined based upon a profile of the user.

In some implementations, the selected interest is determined based upon a plurality of software applications downloaded onto the device.

According to another aspect of the disclosure, a method of delivering an advertisement to a device is provided. The device includes a display and the device is configured to stream a video on the display. The method includes providing an input configured to play, pause, rewind, forward and stop the video. The method further includes loading the advertisement onto the device when the video is played, wherein the advertisement is not visible on the display. For instance, the advertisement may be running in the background. The method further includes playing the advertisement when the video is paused, stopped, rewound or forwarded. The method further includes resuming the video when the input plays the video.

Another instance, the advertisement may be running in the background. The method further includes playing the advertisement when the video is paused, stopped, rewound or forwarded. The method further includes matching the advertisement to be played to be relevant to the genre or theme of current video or Audio being streamed.

Implementations of this aspect of the disclosure may also include one or more of the following features. In some implementations, the video is minimized when the advertisement is played.

In some implementations, the advertisement includes a link for closing the advertisement, the link appearing after a predetermined period of time after the advertisement appears.

In some implementations, the advertisement is one selected from a list of advertisements.

In some implementations, the list of advertisement includes a plurality of advertisements corresponding to a selection of interests selected by a user.

In some implementations, the list of advertisement includes a plurality of advertisements corresponding to a genre or theme of content being streamed.

In some implementations, a compensation is provided to a user each time the advertisement is viewed in full.

According to another aspect of the disclosure, a device is provided. The device includes a display configured to play a media content such as a video or an audio file and an input configured to play, pause, rewind, forward and stop the media content. The user device further includes data processing hardware in communication with the display, input and output. The user device further includes memory hardware in communication with the data processing hardware. The memory hardware stores instructions that when executed on the data processing hardware cause the data processing hardware to perform operations. According to this aspect, the operations carry out a method. The method includes loading the advertisement onto the device when the media content is played, wherein the advertisement is not visible on the display or heard. For instance, the advertisement may be running in the background. The method includes playing the advertisement when the media content is paused, stopped, rewound or forwarded. The method further includes resuming the media content when the input plays the video.

Implementations of this aspect of the disclosure may also include one or more of the following features. In some implementations, the video is minimized when the advertisement is played.

In some implementations, the advertisement includes a link for closing the advertisement, the link appearing at least 2 seconds after the advertisement appears.

In some implementations, the advertisement is one selected from a list of advertisements.

In some implementations, the list of advertisement includes a plurality of advertisements corresponding to a selection of interests selected by a user.

In some implementations, a compensation is provided to a user each time the advertisement is viewed in full or a “call to action” is undertaken.

The details of one or more implementations of the disclosure are set forth in the accompanying drawings and the description below. Other aspects, features, and advantages will be apparent from the description and drawings, and from the claims.

### DESCRIPTION OF DRAWINGS

The embodiments set forth in the drawings are illustrative and exemplary in nature and not intended to limit the subject matter defined herein. The following description of the illustrative embodiments can be understood when read in conjunction with the following drawings, where like structure is indicated with like reference numerals and in which:

FIG. 1A illustrates an exemplary device in accordance with a first aspect of the present disclosure.

FIG. 1B depicts a list of interests displayed on the device shown in FIG. 1A.

FIG. 2 depicts a device showing the execution of a communication operation.

FIG. 3 depicts a device showing the end of a communication operation.

FIG. 4 depicts an advertisement played on the device after the end of a communication.

FIG. 5 illustrates an exemplary aspect showing an option to skip the advertisement.

FIG. 6 illustrates an exemplary system for compensating a user for viewing an advertisement in accordance with the first aspect of the disclosure.

FIG. 7A illustrates an exemplary device in accordance with a second aspect of the present disclosure.

FIG. 7B depicts a list of interests displayed on the device shown in FIG. 7A.

FIG. 7C depicts a list of advertisements based upon a genre.

FIG. 8 video played on the device.

FIG. 9 depicts an advertisement being played.

FIG. 10 illustrates an example of the video being rewound.

FIG. 11 illustrates an exemplary system for displaying an advertisement in accordance with the second aspect of the disclosure.

FIG. 12 is a diagram showing a method according to the first aspect of the disclosure.

FIG. 13 is a diagram showing a method according to the second aspect of the disclosure.

### DETAILED DESCRIPTION

Example implementations provide methods, devices, and systems for compensating a user for viewing advertisements displayed on an electronic device. The method and system may be implemented on an electronic device. The method includes providing a list of interests. The method further includes receiving a selected interest from the list of interests. The method further includes detecting a communication operation executed on the mobile phone. The communication operation may be a phone call, a text message, a video call or the like. The method further includes detecting an end of the communication operation. The method further includes displaying, on the display, a link to view an advertisement related to the selected interest after the end of the communication operation. The method further includes compensating the user when the advertisement is viewed. As used herein, the term “viewed” means that the entirety of the advertisement is played, as such, the user may be compensated even if the user merely listens to the entirety of the advertisement, or just lets the advertisement play in full without every viewing or listening to the advertisement.

In a second embodiment, methods, devices, and systems are provided to deliver advertisement to a user viewing/listening to media on an electronic device. In such an embodiment, the advertisement is played when the media is paused, rewound or forwarded.

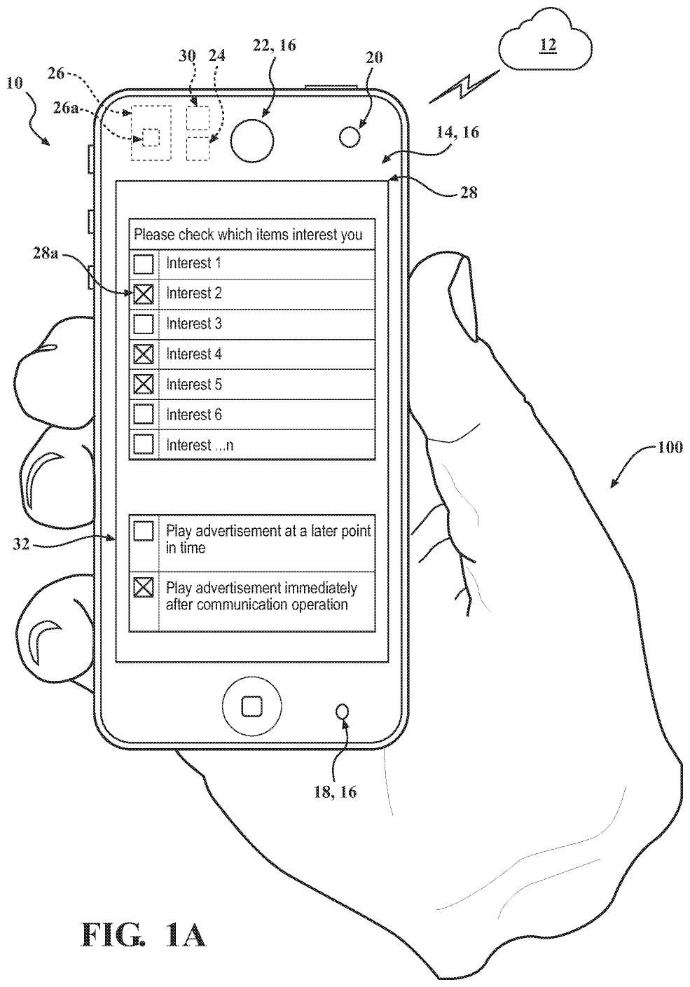

Referring now to FIG. 1A, an exemplary electronic device 10 is provided. The electronic device 10 is shown as a smartphone, but other electronic devices configured to perform communication operations and wirelessly access a remote server 12 may be adapted for use herein, illustratively including a tablet, a desktop, a laptop and the like. As will be described in more detail below, a user 100 may use the electronic device 10 for performing communication operations. As used herein, communication operations is an operation for communicating to a third party, such as texting, instant messaging, phone calls, video calls and the like.

The electronic device 10 may include a display 14, an input module 16. The input module may include a microphone 18, a speaker 20, a camera 22, a keyboard (not shown) and the display 14 in instances where the display 14 is a touch screen. As will be described in more detail below, the communication operation may be performed using a combination of components of the input module 16, such as the microphone 18 and the speaker 20. For instance, during a video call the user 100 may transmit a text message during the video call. In instances, where the communication operation is a phone call, the user 100 may simply engage the microphone 18 and listen through the speaker 20. In instances where the communication operating is text messaging or instant messaging, the user 100 may simply use a text input of the input module 16 such as a keyboard displayed on a touchscreen or the like.

The electronic device 10 includes a data processing hardware 24 and a memory hardware 26. The data processing hardware 24 is in communication with the display 14, input module 16, microphone 18 and speaker 20. The memory hardware 26 is in communication with the data processing hardware 24. The memory hardware 26 stores instructions that when executed on the data processing hardware 24 cause the data processing hardware 24 to perform operations. According to this aspect, the operations carry out a method. The method includes providing a list of interests 28. The list of interests 28 may be list of activities, hobbies, political and environmental causes and the like.

The method further includes receiving a selected interest 28a from the list of interests 28. The user 100 may select an interest from the list of interest so as to provide a selected interest 28a. The method further includes detecting a communication operation executed on the electronic device 10. The communication operation may be a phone call, a text message, a video call or the like. The method further includes detecting an end of the communication operation. The method further includes displaying, on the display 14, a link to view an advertisement related to the selected interest 28a after the end of the communication operation. The method further includes compensating the user 100 when the advertisement is viewed.

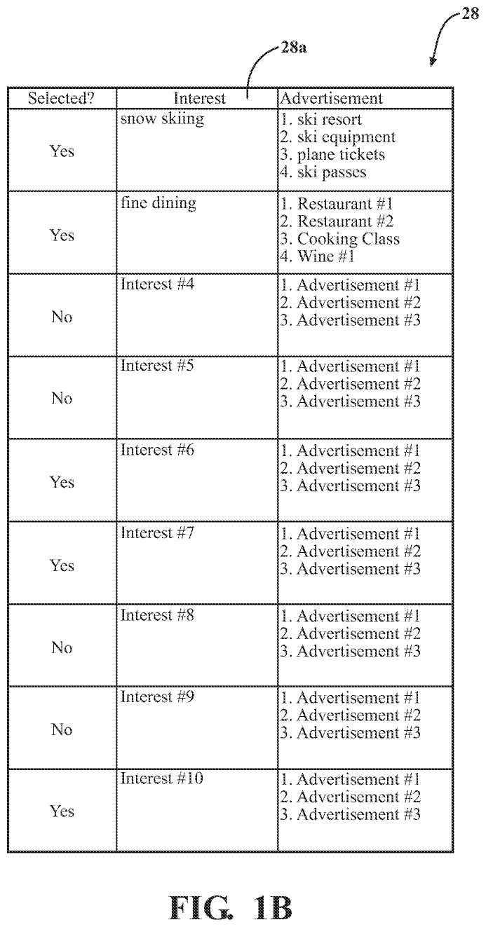

With reference again to FIG. 1A and now to FIG. 2, the electronic device 10 executes a software application 30. The software application 30 may be installed on the electronic device by the manufacturer or may be downloaded from a software application provider that is stored on a remote server 12. The software application 30 executes the steps of the method described herein.

FIG. 1A depicts the software application 30 installed on the electronic device 10. The installation process may include a notification of the operation of the software application 30 and may be subject to the submission of the user's consent to the operation of the software application 30. The installation process may further include the user's registration information. Registration information may include information such as a personal email and contact number and a verification process verifying the submitted information. Upon installation, the software application 30 displays a set up mode. In the set up mode, the software application 30 provides the list of interests 28. The user 100 may simply check a box next to the desired interests. FIG. 1A depicts an instance where there are three checked boxes; however, it should be appreciated that the number of checked boxes may be unlimited.

The interests in the list of interests 28 are shown generally as “interest 1, interest 2 . . . interest n”. The interests may be one of a plurality of items such as activities, hobbies, political and environmental causes and the like. Activities may include sports or recreational activities such as snow skiing, fine dining, kite flying and the like. The interests are un-limiting. The software application 30 may require that the user 100 select an interest among a programmed list of interests 28, or the interests may be manually inputted via an input, such as a keyboard, a microphone 18 with a voice to text software program, or the like. In such an aspect, the software application 30 may be configured to match a manually inputted interests with the advertisements which are available. In the instance where the electronic device 10 is a smartphone, the keyboard appears virtually on the display 14, which is a touch screen. In the case where the electronic device 10 is a tablet or a desktop, the keyboard may coupled to the electronic device 10. The software application 30 may require the user 100 to select a predetermined number of interests. For instance, the software application 30 may require the user 100 to select ten (10) interests.

In one aspect, the selected interests 28a may be based upon a profile of the user 100 or may be based upon the software applications which are downloaded onto the electronic device 10. For example, after the software application 30 has been installed, the software application 30 may request that the user 100 provide access to the social media platform of the user 100 wherein the software application 30 processes the social media platform to generate a user profile and process the user profile to automatically select an interest from the list of interests 28. In another aspect, the software application 30 may request access to the user's electronic device 10 and determine the software applications downloaded onto the electronic device 10, wherein the software application 30 processes the software applications downloaded onto the electronic device 10 so as to select the interests from the list of interests 28. For instance, the user 100 may have downloaded software applications such as Air BnB, Uber, OpenTable, and the like. Such software applications may be processed so as to determine a selected interest 28a from the list of interests 28.

With reference now to FIG. 1B, the selected interests 28a are stored in a database 26a. The database 26a may be housed in the electronic device 10 or stored in a remote server 12. Each of the interests in the list of interests 28 has at least one advertisement associated with the interests. For instance, an interest of snow skiing may have advertisements relating to snow skiing, such as advertisements for a ski resort, ski equipment, plane tickets, ski passes or the like. Accordingly, each of the selected interests 28a are processed by the data processing hardware 24 to retrieve the corresponding advertisements. The corresponding advertisements may be stored locally on the electronic device 10, or may be stored on a remote server 12.

With reference now to FIG. 2, the software application 30 is configured to detect a communication operation. The communication operation may be initiated by the user 100 or a third party caller. For illustrative purposes, the communication operation is shown as an incoming phone call from mom. The software application 30 is configured to select any one of the advertisements corresponding to any one of the selected interests 28a from the list of interests 28. FIG. 1B indicates that the user 100 has selected snow skiing, fine dining, and interests #6, #7 and #10. Accordingly, any one of the advertisements related to a selected interest 28a may be loaded onto the device 10 for viewing, as described in further detail below.

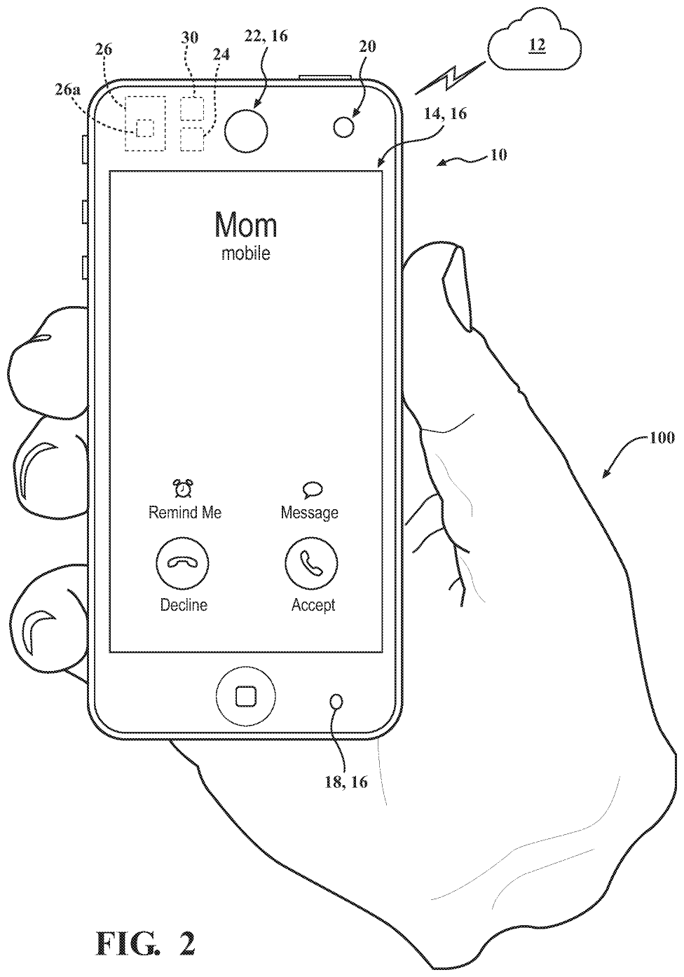

With reference now to FIG. 3, the software application 30 is configured to detect an end of the communication operation. This may be done by detecting an actuation of an end call input or by the detection that the caller has hung up.

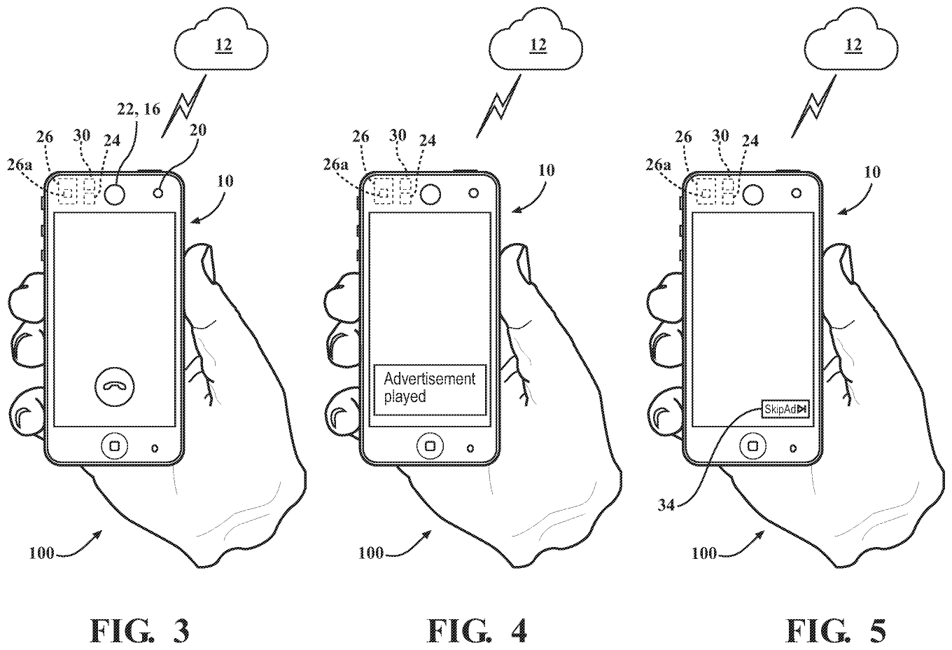

As shown in FIG. 4, the software application 30 is configured to play an advertisement corresponding to one of the selected interests 28a. In one aspect, the advertisement is automatically played after the end of the communication operation. In another aspect, the advertisement may be stored locally or remotely so as to be viewed at a later time. For instance, the software application 30 may provide an advertisement input 32 during the registration or installation of the software application 30, as shown in FIG. 1A. As an example, the advertisement input 32 may appear after the user 100 selects the interests. The advertisement input 32 allows the user 100 the option of having the advertisements played right after the communication operation or at a later point in time. As shown in FIG. 1A, the user 100 has selected that the advertisement is played immediately after a communication operation.

In instances, where the user 100 selects that the advertisement is played at a later point in time, the user 100 may simply open up the software application 30 wherein a menu is a list of advertisements that have not been viewed are provided. As stated above, the advertisements may be stored locally on the electronic device 10 or may be stored remotely. The software application 30 may be configured to provide a notification of advertisements that have not been viewed.

In the case where the advertisements are stored locally, the software application 30 may be configured to erase the advertisement after it has been viewed. In the case where the advertisements are stored remotely, the software application 30 provides a link to view the advertisement. The menu is then updated to remove advertisements which are viewed.

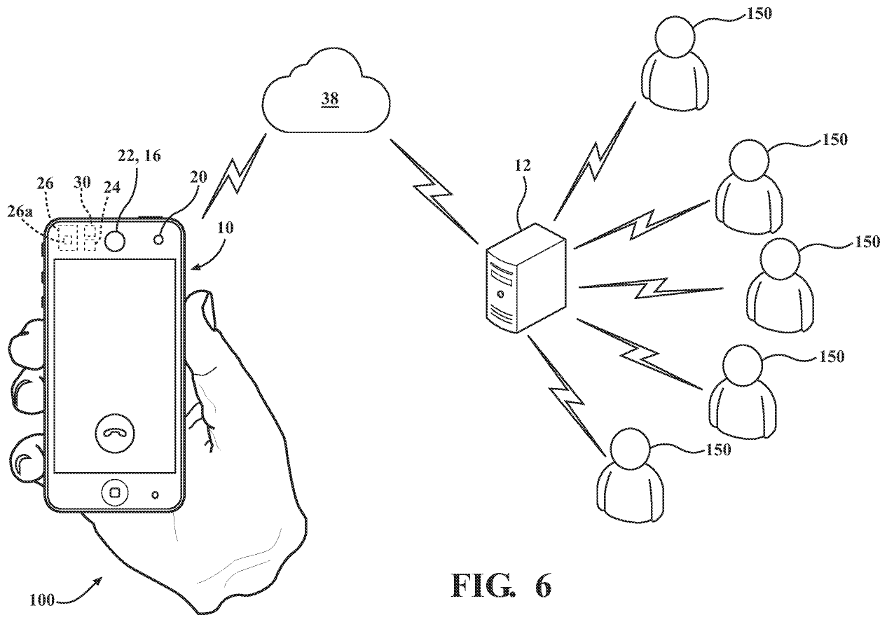

With reference now to FIG. 5, in one aspect of the disclosure, a visual input 34 is provided on the advertisement which allows the user 100 to skip the advertisement. The software application 30 may be further configured to provide another link 36 which allows the user 100 to provide feedback as to the relevance of the advertisement. The software application 30 may be further configured to process the actuation of the visual input and the feedback so as to modify the advertisements which are displayed to the user 100. FIG. 5, shows the visual input 34 and the link 36 as appearing on the display 14 concurrently; however, it should be appreciated that the link 36 and the visual input 34 may be displayed separately. For instance, the link 36 may appear after the visual input 34. Alternatively, the software application 30 may be configured to play the advertisement without interruption and display the link 36 when the advertisement is over.

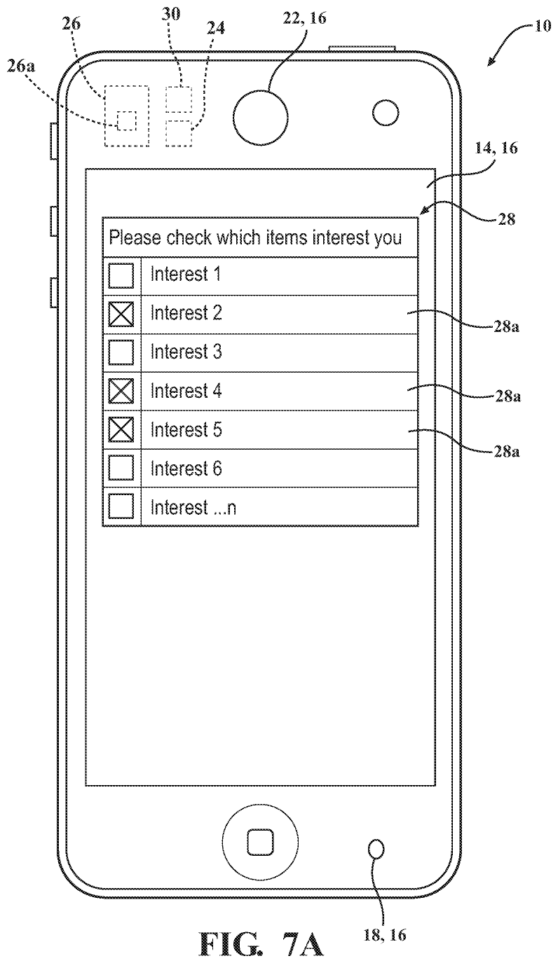

The software application 30 is further configured to compensate the user 100 each time an advertisement is viewed. With reference now to FIG. 6, the electronic device 10 is configured to access a remote server 12 through a network 38. The remote server 12 is uploaded with advertisements provided by advertisers 150. The advertisers 150 may pay to load their advertisements onto the remote server 12. A portion of the payment from the advertisers 150 may be used to compensate the users. The compensation the users 100 receive may be in the form of a rewards points system, wherein the user 100 may redeem earned rewards for discounts, prizes such as tangible goods or digital products or cash. It should be appreciated that the more advertisements viewed by the user 100, the more compensation the user 100 receives. In some aspects, the user may be compensated when the user undertakes a “call to action”. For use herein, a “call to action” refers to a prompt by the advertisement to perform an action such as taking a survey, enrolling in a service or the like.

The network 38 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 38 may include one or more of a Wide Area Network (WAN), a Local Area Network (LAN), and a Personal Area Network (PAN). In some examples, the network 38 includes a combination of data networks, telecommunication networks, or a combination of data and telecommunication networks.

The electronic device 10 and the remote server 12 communicate with each other by sending and receiving signals (wired or wireless) via the network 38. In some examples, the network 38 provides access to cloud computing resources, which may be elastic/on-demand computing and/or storage resources available over the network 38. The term ‘cloud’ services generally refers to a service performed not locally on a user's electronic device 10 (e.g., electronic device 10), but rather delivered from one or more remote electronic devices 10 accessible via one or more networks.

The electronic device 10 includes data processing hardware 24 (a computing electronic device 10 that executes instructions), memory hardware 26, and a display 14 in communication with the data processing hardware 24. Input module 16 provides the user 100 access to interacting with the software application 30 through the electronic device 10. In some examples, the input module 16 includes a keyboard, touchpad, mouse, microphones 18, gesture tracking electronic device, and/or a camera 22 for allowing the user 100 to input data. In addition to or in lieu of the display 14, electronic device 10 may include one or more speakers 20 to output audio data to the user 100.

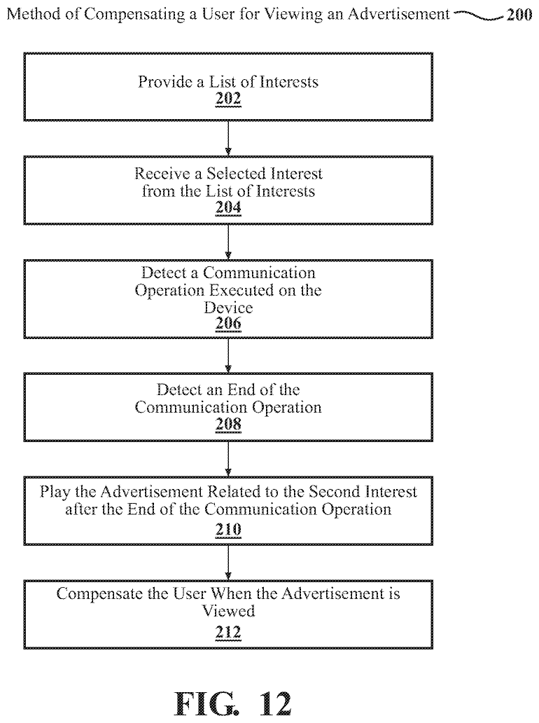

FIG. 12 is a flow chart illustrating a method 200 for compensating. According to one example, the method 200 may be performed by an electronic device 10 having a software application 30. The method 200 begins at block 202 where the software application 30 provides the list of interests 28 which may be displayed on the display 14. The number of interest in the list is unlimiting, and the user 100 may simply scroll up or down on the list to view all of the interests.

At block 204, the method 200 includes receiving a selected interest 28a from the list of interests 28. The software application 30 may require that the user 100 select an interest among a programmed list of interests 28, or the interests may be manually inputted via an input, such as a keyboard, a microphone 18 with a voice to text software program, or the like. In the instance where the electronic device 10 is a smartphone, the keyboard appears virtually on the display 14 and in the case where the electronic device 10 is a tablet or a desktop, the keyboard may coupled to the electronic device 10.

At block 206, the method 200 includes detecting a communication operation executed on the electronic device 10. For example, when the communication operation is a phone call. The software application 30 may process the electronic device 10 functions to determine an incoming call or a placed call which indicates a communication operation.

At block 208, the method 200 includes detecting an end of the communication operations. This may be done by detecting an actuation of an end call input or by the detection that the caller has hung up.

At block 210, the method 200 includes playing the advertisement related to the selected interest 28a after the end of the communication operation. In one aspect, as shown in FIG. 4, the software application 30 is configured to play an advertisement corresponding to one of the selected interests 28a. In one aspect, the advertisement is automatically played after the end of the communication operation. In another aspect, the advertisement may be stored locally or remotely so as to be viewed at a later time.

At block 212 the method 200 includes compensating the user 100 when the advertisement is viewed. As discussed above, the compensation may be based off of a reward system wherein users 100 may redeem reward points for items, discounts or cash. Following block 212, the method 200 may conclude.

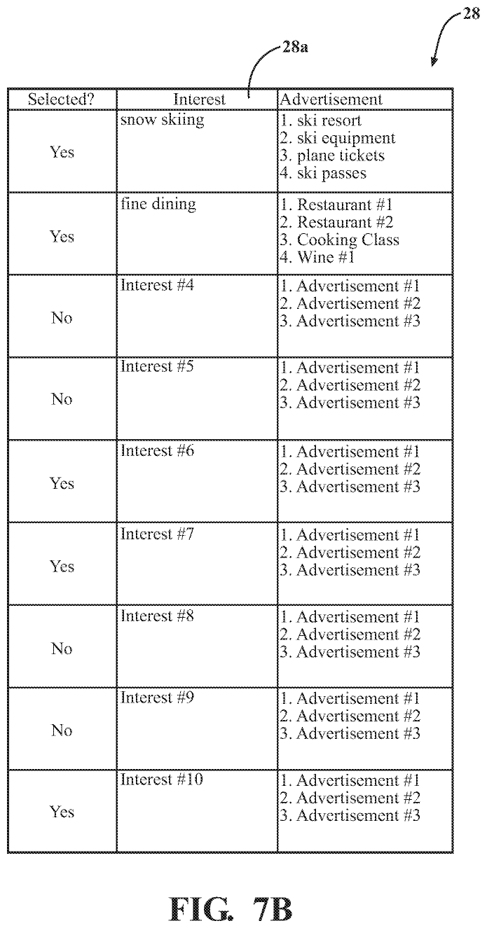

With reference now to FIGS. 7A-7C, another aspect of the disclosure is provided wherein a method, an electronic device 10 and system are directed to deliver an advertisement to an electronic device 10. The electronic device 10 may include a display 14 and an input module 16. The electronic device 10 is configured to play a media content on the display 14. For instance, the media content may be a video streamed from an internet based platform or may be an audible service such as a podcast. For illustrative purposes, the media content is shown as being a video.

The electronic device 10 includes a data processing hardware 24 and memory hardware 26. The data processing hardware 24 is in communication with the display 14 and the input module 16. The memory hardware 26 is in communication with the data processing hardware 24. The memory hardware 26 stores instructions that when executed on the data processing hardware 24 cause the data processing hardware 24 to perform operations. According to this aspect, the operations carry out a method. The method includes actuating the input module 16 to play, pause, rewind, forward and stop the video. The method further includes loading the advertisement onto the electronic device 10 when the video is played, wherein the advertisement is not visible on the display 14. For instance, the advertisement may be running in the background or simply loaded in the background so as to be ready to be played. The method further includes playing the advertisement when the video is paused, stopped, rewound or forwarded. The method further includes resuming the video when the input plays the video.

FIG. 7A depicts the software application 30 installed on the electronic device 10. The installation may include a notification of the operation of the software application 30 and may be subject to the submission of the user's consent to the operation of the software application 30 and the user's registration information. Registration information may include information such as a personal email and contact number and a verification process verifying the submitted information. Upon installation, the software application 30 displays a set up mode. In the set up mode, the software application 30 may provide a list of interests 28. The user 100 may simply select an interest by checking a box next to the desired interests. FIG. 7A depicts an instance where there are three checked boxes; however, it should be appreciated that the number of checked boxes may be unlimited.

The list of interests 28 are shown generally as “interest 1, interest 2 . . . interest n”. The interests may be one of a plurality of items such as activities, hobbies, political and environmental causes and the like. Activities may include sports or recreational activities such as snow skiing, fine dining, kite flying and the like. The interests are un-limiting. The software application 30 may require that the user 100 select an interest among a programmed list of interests 28, or the interests may be manually inputted via an input, such as a keyboard, a microphone 18 with a voice to text software program, or the like. In such an aspect, the software application 30 may be configured to match a manually inputted interests with the advertisements which are available. In the instance where the electronic device 10 is a smartphone, the keyboard appears virtually on the display 14 and in the case where the electronic device 10 is a tablet or a desktop, the keyboard may coupled to the electronic device 10. The software application 30 may require the user 100 to select a predetermined number of interests. For instance, the software application 30 may require the user 100 to select ten (10) interests.

In one aspect, the selected interests 28a may be based upon a profile of the user 100 or may be based upon the software applications 30 which are downloaded onto the electronic device 10. For example, after the software application 30 has been installed, the software application 30 may request that the user 100 provide access to the user's social media platform wherein the software application 30 processes the user's social media platform to generate a user profile and process the user profile to automatically select an interest from the list of interests 28. In another aspect, the software application 30 may request access to the user's electronic device 10 and determine the software application downloaded onto the electronic device 10, wherein the software application 30 processes the software application downloaded onto the electronic device 10 so as to select the interests from the list of interests 28. For instance, the user 100 may have downloaded software applications such as Air BnB, Uber, OpenTable, and the like. Such software applications may be processed so as to determine a selected interest 28a from the list of interests 28.

With reference now to FIG. 7B, the selected interests 28a are stored in a database 26a. The database 26a may be housed in the electronic device 10 or stored in a remote server 12. Each of the interests in the list of interests 28 has at least one advertisement associated with the interests. For instance, an interest of snow skiing may have advertisements relating to snow skiing, such as advertisements for a ski resort, ski equipment, plane tickets, ski passes or the like. Accordingly, each of the selected interests 28a are processed by the data processing hardware 24 to retrieve the corresponding advertisements. The corresponding advertisements may be stored locally on the electronic device 10, or may be stored on a remote server 12.

With reference now to FIG. 7C, another aspect of the software application 30 is provided wherein the software application 30 may be configured to match a genre with the advertisements which are available. The advertisement is loaded onto the electronic device 10 when the video is played, wherein the advertisement is not visible on the display 14. For instance, the advertisement may be running in the background or simply loaded in the background so as to be ready to be played. The method further includes playing the advertisement when the video is paused, stopped, rewound or forwarded. The method further includes resuming the video when the input plays the video. In such an aspect, the genre of the media content may be identified by metadata or any other tags which may be embedded in the media content. FIG. 7C provides an example of genres for different media content. For instance, genres are identified for audio files, which may be music files or podcasts. Genres are also identified for video files, which are either streamed or downloaded. The advertisements are played when the media content is interrupted by a pause, stop, rewind or forward input.

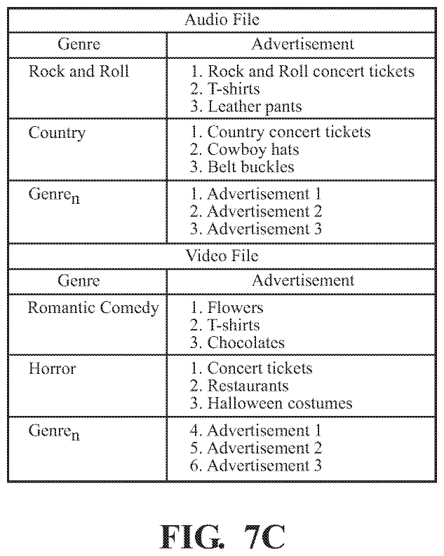

With reference now to FIG. 8, the software application 30 is configured load the advertisement onto the electronic device 10 when the video is played. As used herein, the term load does not necessarily require a download of an actual file, but may include a link to the advertisement which is stored in a remote server 12. As shown in FIG. 8, the advertisement is hidden by the video. As such, the user 100 cannot view the advertisement.

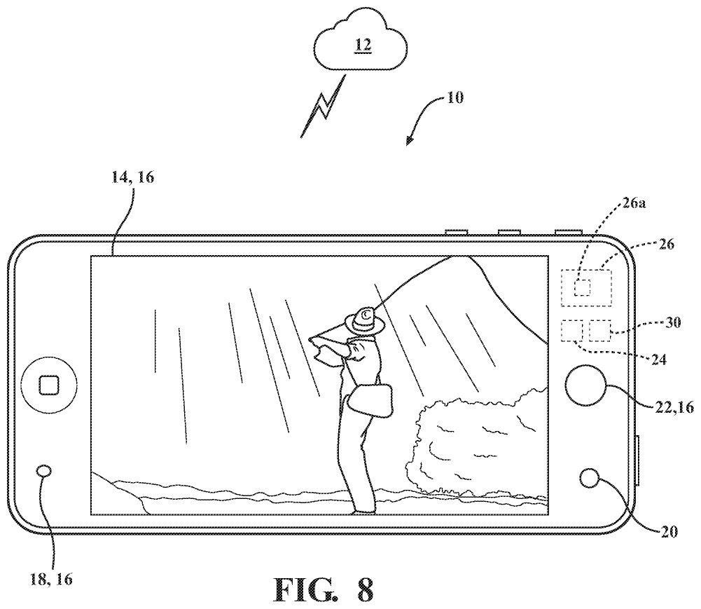

With reference now to FIG. 9, the user 100 actuates the input module 16 to pause the video, wherein the advertisement is played. For illustrative purposes, the input module is shown as a plurality of icons displayed on a touch screen display. FIG. 9, depicts an embodiment where the video is minimized. However; it should be appreciated that the video may be completely hidden and the advertisement is fully displayed on the display 14. In one aspect, the advertisement includes a visual input 34, the visual input 34 is a link that is configured to close the advertisement. For illustrative purposes, the visual input 34 is shown as an icon labeled “SkipAd”. In such an aspect, the link may not be operable for three seconds after the advertisement has begun playing.

As discussed above, the advertisement may be based upon the selected interests 28a. As such, a different advertisement may be displayed after each pause, rewind or forward of a video. The software application 30 is configured to detect the pause, rewind or forward. This may be done by processing the tactile input of the display 14. In other aspects, such as an aspect where the electronic device 10 is a computer the software application 30 may process the input from an input module 16 having a mouse or a keyboard. In instances where the electronic device 10 is a television, such as a television with a Roku Box or a firestick, the pause, rewind or forward may be detected by processing a corresponding pause, rewind or forward button of a remote control, which functions as the input module 16.

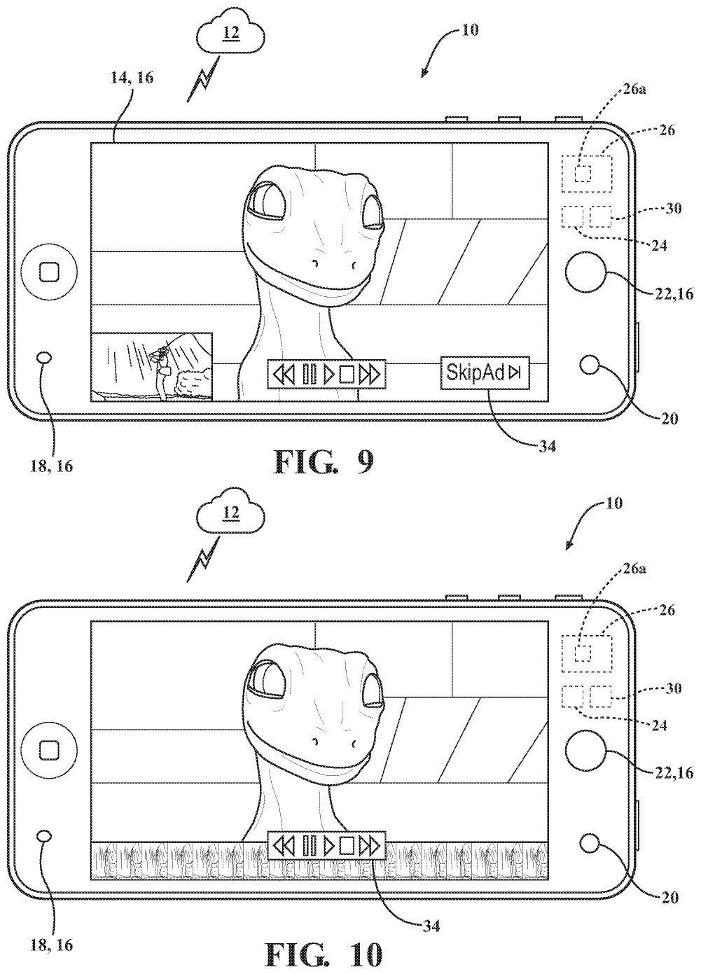

FIG. 10 depicts an embodiment where the user 100 is rewinding the video, this may be done by providing a visual input 34 which is an icon unit containing a plurality of icons configured to play, stop, rewind or fast forward the video. The user simply touches the rewind icon. In such an aspect, the individual frames of the video are shown minimized and the rewinding function allows the user 100 to scroll to a desired frame, wherein the advertisement is played simultaneously. In such an aspect, the video will not play until the advertisement has been viewed or a link appears to close the advertisement.

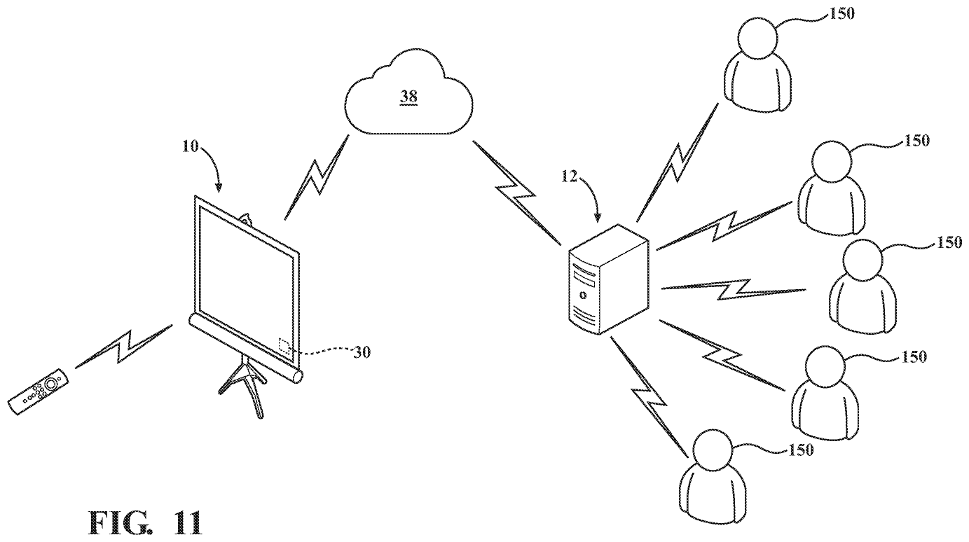

With reference now to FIG. 11, the software application 30 may be further configured to compensate the user 100 each time an advertisement is viewed. In such an aspect, the electronic device 10 is configured to access a remote server 12 through a network 38. The remote server 12 is uploaded with advertisements provided by advertisers 150. The advertisers 150 may pay to load their advertisements onto the remote server 12. The compensation the users receive may be in the form of a rewards points system, wherein the user 100 may redeem earned rewards for discounts, prizes or cash.

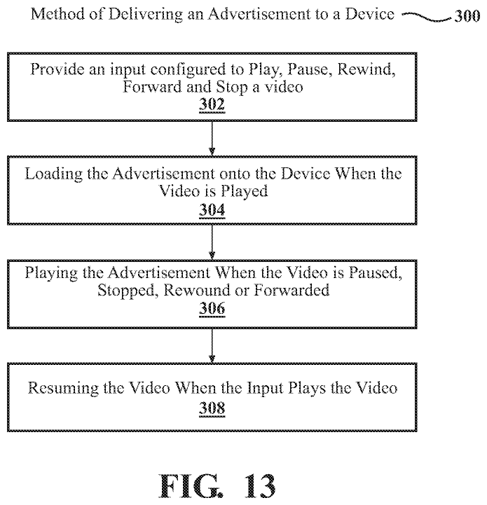

FIG. 13 is a flow chart illustrating a method 300 for compensating. According to one example, the method 300 may be performed by an electronic device 10 having a software application 30. The method 300 begins at block 302 where an input module 16 is provided, the input module 16 is configured to play, pause, rewind, forward and stop the video. As described above, the input module 16 may be embodied as a touchscreen display, as in the case where the electronic device 10 is a smartphone or a tablet; or a remote control as in the case where the electronic device 10 is a television, such as a smart television or a television coupled to a smart box such as a Roku box or a firestick.

At block 304, the method 300 includes loading the advertisement onto the electronic device 10 when the video is played. The advertisement is hidden by the video. That is, the video is not affected by the loading of the advertisement, wherein the advertisement is not visible on the display 14. In one aspect, the software application 30 is configured to load an advertisement corresponding to one of the selected interests 28a.

At block 306 the method 300 includes playing the advertisement when the video is paused, stopped, rewound or forwarded. According to one aspect, the user 100 may be compensated for each advertisement that is viewed. The compensation the users receive may be in the form of a rewards points system, wherein the user 100 may redeem earned rewards for discounts, prizes or cash.

At block 308, the method 300 includes resuming the video when the input module 16 plays the video. It should be appreciated that an advertisement will appear each time the user 100 pauses, rewinds, or forwards the video. Further, as the advertisements may be based upon the interests of the user 100, the advertisements may be relevant to the interests of the user 100. Further, users 100 are incentivized to view the advertisements through the rewards system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input electronic device, and at least one output electronic device.

These computer programs (also known as programs, software, software application 30s or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or electronic device (e.g., magnetic discs, optical disks, memory, Programmable Logic Electronic devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware 24, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory electronic devices for storing instructions and data. Generally, a computer will also include, or be operatively coupled to receive data from or transfer data to, or both, one or more mass storage electronic devices for storing data, e.g., magnetic, magneto optical disks, or optical disks. However, a computer need not have such electronic devices. Computer readable media suitable for storing computer program instructions and data include all forms of non-volatile memory, media and memory electronic devices, including by way of example semiconductor memory electronic devices, e.g., EPROM, EEPROM, and flash memory electronic devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user 100, one or more aspects of the disclosure can be implemented on a computer having a display electronic device, e.g., a CRT (cathode ray tube), LCD (liquid crystal display) monitor, or touch screen for displaying information to the user 100 and optionally a keyboard and a pointing electronic device 10, e.g., a mouse or a trackball, by which the user 100 can provide input to the computer. Other kinds of electronic devices 10 can be used to provide interaction with a user 100 as well; for example, feedback provided to the user 100 can be any form of sensory feedback, e.g., visual feedback, auditory feedback, or tactile feedback; and input from the user 100 can be received in any form, including acoustic, speech, or tactile input.

A software application 30 (i.e., a software resource) may refer to computer software that causes a computing electronic device 10 to perform a task. In some examples, a software application 30 may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical electronic devices used to store programs (e.g., sequences of instructions) or data (e.g., program state information) on a temporary or permanent basis for use by a computing electronic device 10. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of compensating a user operating a device having a display, the method including the steps of:
providing a list of interests;
receiving a selected interest from the list of interests;
detecting a communication operation executed on the device;
detecting an end of the communication operation;
playing an advertisement related to the selected interest after the end of the communication operation; and
compensating the user when the advertisement is viewed.

2. The method as set forth in claim 1, wherein an advertisement input is provided which provides an option to view the advertisement instantaneously or at a later point in time.

3. The method as set forth in claim 1, wherein the advertisement may be closed after a predetermined period of time.

4. The method as set forth in claim 1, wherein the compensation may be a credit redeemable for a monetary amount or a tangible good.

5. The method as set forth in claim 1, further including an input for selecting one of the interests from the list of interests.

6. The method as set forth in claim 1, wherein the selected interest is determined based upon a profile of the user.

7. The method as set forth in claim 1, wherein the selected interest is determined based upon a plurality of software applications downloaded onto the device.

8. An electronic device comprising:
a display, a text input, a microphone and a speaker;
data processing hardware in communication with the display; and
a memory hardware in communication with the data processing hardware, the memory hardware storing instructions that when executed on the data processing hardware cause the data processing hardware to perform operations including:
providing a list of interests;
receiving a selected interest from the list of interests;
detecting a communication operation executed on the device;
detecting an end of the communication operation;
displaying, on the display, a link to view an advertisement related to the selected interest after the end of the communication operation; and
compensating the user when the advertisement is viewed.

9. The electronic device as set forth in claim 8, wherein the link includes an option to view the advertisement instantaneously or at a later point in time.

10. The electronic device as set forth in claim 8, wherein the advertisement includes an input configured to close the advertisement after a predetermined period of time.

11. The electronic device as set forth in claim 8, wherein the compensation may be a credit redeemable for a monetary amount.

12. The electronic device as set forth in claim 8, further wherein the text input may be configured to select one of the interests from the list of interests.

13. The electronic device as set forth in claim 8 wherein the selected interest is determined based upon a profile of the user.

14. The electronic device as set forth in claim 8, wherein the selected interest is determined based upon a plurality of software applications downloaded onto the device.

15. A method of delivering an advertisement to a device having a display, the device configured to play a media content, the method including the steps of:
providing an input configured to play, pause, rewind, forward and stop the media content;
loading the advertisement onto the device when the media content is played, wherein the advertisement is not visible on the display;
playing the advertisement when the media content is paused, stopped, rewound or forwarded; and
resuming the media content when the input plays the media content.

16. The method as set forth in claim 15, wherein the media content is minimized when the advertisement is played.

17. The method as set forth in claim 15, wherein the advertisement includes a link for closing the advertisement, the link appearing after a predetermined period of time after the advertisement appears.

18. The method as set forth in claim 15, wherein the advertisement is one selected from a list of advertisements.

19. The method as set forth in claim 18, wherein the list of advertisement includes a plurality of advertisements corresponding to a selection of interests selected by a user.

20. The method as set forth in claim 19, wherein a compensation is provided to a user each time the advertisement is viewed in full.

21. The method as set forth in claim 18, wherein the list of advertisement includes a plurality of advertisements corresponding to a genre associated with the media content.

22. An electronic device configured to play a media content, the device comprising:
a display configured to play the media content;
an input configured to play, pause, rewind, forward and stop the media content;
data processing hardware in communication with the display; and
a memory hardware in communication with the data processing hardware, the memory hardware storing instructions that when executed on the data processing hardware cause the data processing hardware to perform operations including:
loading an advertisement onto the device when the video or Audio is played, wherein the advertisement is not visible on the display;
playing the advertisement when the media content is paused, stopped, rewound or forwarded; and
resuming the media content when the input plays the media content.

23. The electronic device as set forth in claim 22, wherein the media content is minimized or muted when the advertisement is played.

24. The electronic device as set forth in claim 22, wherein the advertisement includes a link for closing the advertisement.

25. The electronic device as set forth in claim 22, wherein the advertisement is one selected from a list of advertisements.

26. The electronic device as set forth in claim 25, wherein the list of advertisement includes a plurality of advertisements corresponding to a selection of interests selected by a user.

27. The electronic device as set forth in claim 26, wherein a compensation is provided to a user each time the advertisement is viewed.

28. The electronic device as set forth in claim 25, wherein the list of advertisement includes a plurality of advertisements corresponding to a genre associated with the media content.
